(19) United States
(12) Patent Application Publication
(10) Pub. No.: US 2025/0097259 A1
(43) Pub. Date: Mar. 20, 2025

(54) DIGITAL TWIN-ENABLED DDOS ATTACK DETECTION SYSTEM AND METHOD FOR AUTONOMOUS CORE NETWORKS

(71) Applicant: BTS KURUMSAL BILISIM TEKNOLOJILERI ANONIM SIRKETI, Istanbul (TR)

(72) Inventors: Mertkan AKKOÇ, Besiktas, Istanbul (TR); Gökhan YURDAKUL, Istanbul (TR); Berk CANBERK, Istanbul (TR); Aytaç KARAMESEOGLU, Istanbul (TR); Bahadir BAL, Copenhagen (DK); Yagmur YIGIT, Istanbul (TR)

(21) Appl. No.: 18/294,479

(22) PCT Filed: Nov. 1, 2022
(86) PCT No.: PCT/TR2022/051216

§ 371 Date: Feb. 1, 2024

(30) Foreign Application Priority Data
Sep. 15, 2022 (TR) 2022/014290

(51) Int. Cl. H04L 9/40

(52) U.S. Cl. CPC H04L 63/1458

(57) ABSTRACT

Disclosed is a system and method that ensures the timely and accurate detection of a Distributed Denial of Service (DDoS) attack when it occurs in the core networks of an Internet Service Provider (ISP).

### TECHNICAL FIELD

The invention is related to the system and method that ensures the timely and accurate detection of the Distributed Denial of Service (DDoS) attack when it occurs in the core networks of an Internet Service Provider (ISP).

### BACKGROUND ART

Nowadays, it is important for an ISP to exchange data without loss at high speed and without breaking the connection between the content providers and the end users. To this end, it is necessary to constantly monitor the core network and to interfere in a timely manner when necessary. When DDoS attacks occur, the sudden increase in data rates in core networks causes loss of data and disconnection between the core network and the user. Monitoring and network management methods in the literature are not efficient in detecting the DDoS attack and repairing the network after the attack. In addition, these methods are limited to data centers or border networks and do not address the entire network. This situation causes ISPs to not be able to fully manage their networks.

Offline learning methods in the literature cannot produce stable and consistent responses in real time and cannot adapt to the high volume, diverse and variable data that occurs during DDoS attacks. In addition, among the obtained data, the most suitable features to be used in learning are not selected and the data is not modeled in these methods. This situation causes the previous detection methods to work inefficiently.

Some of the available academic references are:
1. Y. Wu, K. Zhang, and Y. Zhang, “Digital Twin Networks: A Survey,” IEEE Internet of Things Journal, vol. 8, no. 18, pp. 13 789-13 804, May 2021.
2. J. Boite, P.-A. Nardin, F. Rebecchi, M. Bouet, and V. Conan, “Statesec:Stateful monitoring for DDoS protection in software defined networks,” in IEEE Conference on Network Softwarization (NetSoft), Bologna, Italy, July 2017, pp. 1-9.
3. Z. K. Maseer, R. Yusof, N. Bahaman, S. A. Mostafa, and C. F. M. Foozy, “Benchmarking of Machine Learning for Anomaly Based Intrusion Detection Systems in the CICIDS2017 Dataset,” IEEE Access, vol. 9, pp. 22 351-22 370, Feb. 2021.
4. K. Sadaf and J. Sultana, “Intrusion detection based on autoencoder and isolation forest in fog computing,” IEEE Access, vol. 8, pp. 167 059-167 068, Sept. 2020.
5. T. T. Khoei, G. Aissou, W. C. Hu, and N. Kaabouch, “Ensemble Learning Methods for Anomaly Intrusion Detection System in Smart Grid,” in 2021 IEEE International Conference on Electro Information Technology (EIT), July 2021, pp. 129-135.
6. Y. Wei, J. Jang-Jaccard, F. Sabrina, A. Singh, W. Xu, and S. Camtepe, “Ae-mlp: A hybrid deep learning approach for ddos detection and classification,” IEEE Access, vol. 9, pp. 146 810-146 821, Oct. 2021.
7. T. Alsop. Average cost per hour of enterprise server downtime worldwide in 2019. [Online]. Available: https://www.statista.com/statistics/753938, Accessed Sep. 9, 2021.
8. Saad, S. Faddel, T. Youssef, and O. A. Mohammed, “On the Implementation of IoT-Based Digital Twin for Networked Microgrids Resiliency Against Cyber Attacks,” IEEE Transactions on Smart Grid, vol. 11, no. 6, pp. 5138-5150, June 2020.
9. Y. Xie, “Modified Label Propagation on Manifold With Applications to Fault Classification,” IEEE Access, vol. 8, pp. 97 771-97 782, May. 2020.
10. C. Zhou, H. Yang, X. Duan, D. Lopez, A. Pastor, Q. Wu, M. Boucadair, and C. Jacquenet. Digital Twin Network: Concepts and Reference Architecture. [Online]. Available: https://datatracker.ietf.org/doc/html/draft-zhou-nmrg-digitaltwin-network-concepts-06, Accessed Dec. 15, 2021.
11. M. Bjorklund. YANG—A Data Modeling Language for the Network Configuration Protocol (NETCONF), RFC 6020. [Online]. Available: https://rfc-editor.org/rfc/rfc6020.txt, Accessed Jul. 25, 2021.
12. Sharafaldin, A. H. Lashkari, S. Hakak, and A. A. Ghorbani. DDoS Evaluation Dataset (CIC-DDoS2019). [Online]. Available: https://www.unb.ca/cic/datasets/ddos-2019.html, Accessed Jun. 21, 2021.
13. N. Moustafa. ToN IoT Datasets. [Online]. Available: https://ieee-dataport.org/documents/toniot-datasets, Accessed Jun. 21, 2021.
14. O. R. Sanchez, M. Repetto, A. Carrega, and R. Bolla, “Evaluating ML-based DDoS Detection with Grid Search Hyperparameter Optimization,” in 2021 IEEE 7th International Conference on Network Softwarization (NetSoft), July 2021, pp. 402-408.

As a result, due to the problems described above and the inadequacy of the existing methods on the subject, it was necessary to make an improvement in the relevant technical field.

### Purpose of the Invention

The invention aims to propose a system with innovative technical features that brings a new perspective to this field, unlike the structures used in existing systems.

The main purpose of the invention is to create and observe the digital twin of the core network and to detect DDoS attacks autonomously using online learning methods. The invention also enables the processing of high volumes of data obtained by modeling the data and autonomously selecting features. Thanks to the invention, a DDoS attack can be detected quickly and accurately, thus preventing further damage to the core network. This invention also contributes to the autonomous core network concept of the future.

The invention proposes to use an online learning method in order to detect DDoS attacks that occur in core networks. Thus, the proposed learning method can improve its learning capabilities under diverse and high volumes of data caused by the attack, unlike the offline machine learning methods. In addition, the technology of digital twin creation was used to obtain data by interfering with the digital twin of the network to observe the network remotely, instead of directly interfering with the physical network. To this end, the digital twin of all physical assets in the network was created, and the data was collected over these digital twins. Thanks to the proposed method, intervention in the physical network can be carried out through the digital twin, and this makes the management of the network autonomous.

In the invention, the data modeling language YANG (Yet Another Next Generation) was used to model the data to be sent as input to online machine learning management. Thus, data redundancy, which occurs by taking all data from different sensor paths of different routers, and a slowdown in the system is prevented. The data of two performance indicators (Key Performance Indicator (KPI)) were modeled using YANG sensor paths within the scope of the invention and a reduction was achieved in the data to be processed. After this operation, the dynamic feature selection process was applied to these obtained data. For this process, the AutoFS module was created, which dynamically chooses the feature selection method that will give the best result according to the result metrics of the learning algorithm among six different feature selection methods. ANOVA (Analysis of Variance), F-value Selection, Chi-square, BFE (Backward Feature Elimination), Fisher Score, and RFE (Recursive Feature Elimination) were chosen as six different feature selection methods. With the YANG and AutoFS methods, the problem of not considering all the assets in the network was prevented and the system was enabled to work on all routers. In the final step, K-Means and EM algorithms were combined in the invention to make the learning process online. Thus, online machine learning was realized by updating the parameters of the Feature Selection Module used in the system and the MLP (Multilayer Perceptron/Multilayer Perceptron) in the Online Learning Module, according to the network status, thanks to the AutoFS module.

The invention is the system that ensures timely and accurate detection of the problem when a DDoS/distributed denial of service attack occurs in the core/physical networks of each ISP and contains the features listed below:
The physical network owned by the ISP, through which data flow is provided to the users,
The cloud system that runs the created digital twin of the physical network,
The digital twin of the router, which is located in the digital twin of the physical network and performs the machine learning, data modeling, feature selection and data labeling methods in the system,
YANG data models that prevent the high volume of data that will occur by modeling the key performance indicator data received from the routers,
Feature selection module that performs feature selection on modeled data to be used during online learning,
Online learning module that performs the online learning method on the data obtained, using the MLP method,
Classification module that decides whether the traffic change in the network is a DDoS attack or not according to the result obtained from the learning process,
Performance evaluation module, which gives feedback to the feature selection process on the data by looking at the performance metrics obtained as a result of online learning,
The AutoFS module, which determines the most appropriate feature selection method among the specified feature selection methods, according to the feedback from both the performance evaluation module and the module that contains up-to-date feature information. This module also enables online learning to process.
The module that contains up-to-date feature information according to the notifications coming from the performance evaluation module.

The structural and characteristic features of the invention and all its advantages will be understood more clearly thanks to the figures given below and the detailed description written with reference to these figures. For this reason, the valuation should be made by taking these figures and detailed explanation into consideration.

### FIGURES TO HELP UNDERSTAND THE INVENTION

FIG. 1, the schematic representation of the system proposed in the invention.

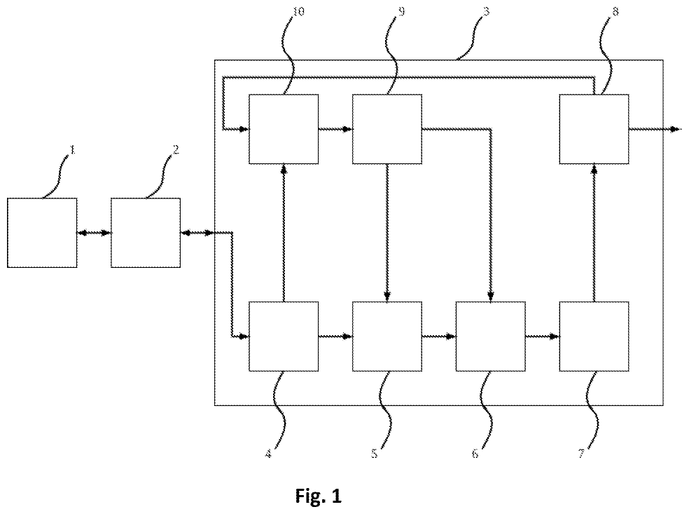

FIG. 2, the schematic representation of the method proposed in the invention.

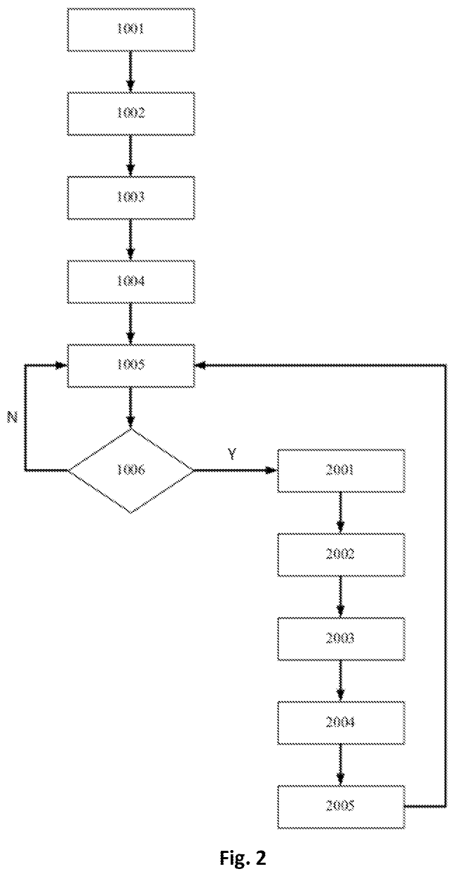

FIG. 3, the schematic representation of the method proposed in the invention.

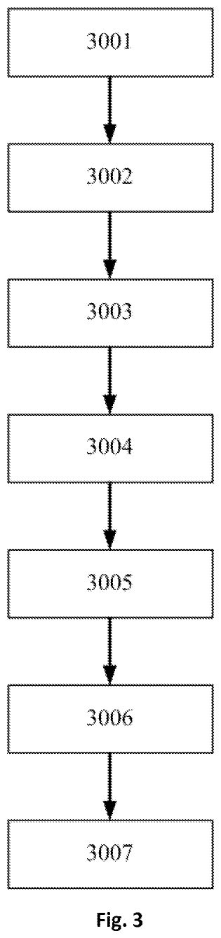

FIG. 4, the general representation of the system proposed in the invention.

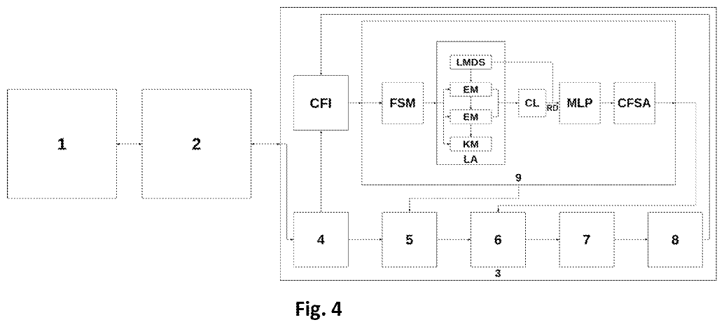

Drawings are not necessarily to scale and details not necessary for understanding the present invention may be omitted. Furthermore, features that are at least substantially identical or have at least substantially identical functions are denoted by the same number.

### DESCRIPTION OF FEATURE REFERENCES

1. The Physical Network
2. The Cloud System
3. The Digital Twin of the Router
4. YANG Data Models
5. Feature Selection Module
6. Online Learning Module
7. Classification Module
8. Performance Evaluation Module
9. The AutoFS Module
10. The Module that Contains the Up-To-Date Feature Information

### Abbreviations

Y: Yes
N: No
CFI: Current Feature Information
FSM: Feature Selection Methods
LD: Labeled Data
LMDS: Labeled Main Data Set
LA: Labeling Algorithm
EM: Expectation Maximization
KM: K-Means
CL: Collective Learning
RD: Result Data
MLP: Multilayer Perceptron
CFSA: Chosen Feature Selection Algorithm
ANOVA: Analysis of Variance
BFE: Backward Feature Elimination
RFE: Recursive Feature Elimination
EM: Expectation Maximization
DDoS: Distributed Denial of Service Attack

### DETAILED DESCRIPTION OF THE INVENTION

In this detailed description, preferred embodiments of the invention are explained only for a better understanding of the subject and without any limiting effect.

The invention is related to the system and method that ensures the timely and accurate detection of the DDoS attack when it occurs in the physical core networks (1) of an ISP.

The modules and functions used in the system and method of the invention are as follows:

The physical network (1) is owned by the ISP, through which data flow is provided to the users.

The cloud system (2) is the structure that runs the created digital twin of the physical network (1).

The digital twin of a router (3) is the structure that is located in the digital twin of the physical network (1) and performs the machine learning, data modeling, feature selection and data labeling methods in the system.

YANG data models (4) is the structure that prevents the high volume of data that will occur by modeling the key performance indicator data received from the routers.

Feature selection module (5) is the structure that performs feature selection on modeled data to be used during online learning.

Online learning module (6) is the structure that performs the online learning method on the data obtained using the MLP method.

Classification module (7) is the structure that decides whether the traffic change in the network is a DDoS attack or not according to the result obtained from the learning process.

Performance evaluation module (8) is the structure that gives feedback to the feature selection process on the data by looking at the performance metrics obtained as a result of online learning.

The AutoFS module (9) is the structure that determines the most appropriate feature selection method among the specified feature selection methods, according to the feedback from the performance evaluation module (8) and the module that contains the up-to-date feature information (10). This is the module that enables online learning.

The module that contains up-to-date feature information (10) according to the notifications coming from the performance evaluation module (8).

The working principle of the proposed system of the invention, is as follows:

In the proposed method of invention, firstly, the digital twin of the physical core network (1) owned by the ISP is created. The created digital twin is run in the cloud system (2). The information on two performance indicators determined within the scope of the invention is collected from the digital twin of the router (3) using the YANG data model (4). The YANG data model (4) is used to reduce the amount of data and the complexity of the system in these collected data. Based on the data collected through these performance indicators, the best ten features to be used in the online learning module (6) are determined by the feature selection module (5) from the module that contains up-to-date feature information (10). The data, whose features are determined, are labeled in the AutoFS module (9) using the proposed labeling method, before being fed to the online learning module (6). The Ensemble Learning Algorithm, which combines K-Means and EM algorithms, is proposed as a labeling method in the invention. After labeling the data, these labeled data are fed into the online learning module (6) for training and testing. Then, the classification of whether the traffic change occurring in the network is a DDoS attack is made in the classification module (7) using the MLP method trained in the online learning module (6).

In the performance evaluation module (8), performance metrics (sensitivity (recall) and detection time) are checked over the generated classification output. The learning process continues with the determined features and feature selection methods if the determined performance metrics are above certain threshold values in the online learning module (6). However, if the values of the performance metrics are below a certain threshold value, the selected features and MLP parameters are updated using the AutoFS module (9). The feature update process is carried out by determining the best feature selection method that will optimize the performance metrics among the six feature selection methods determined within the scope of the invention. The selected feature selection method chooses the top ten features according to its own algorithm. After the data has been relabeled, it is fed into the MLP learning method in the online learning module (6). The feature selection method and features used by the MLP method are determined by dynamically changing according to the values of the performance metrics in the AutoFS module (9). Thus, the MLP method can adapt to changing conditions in an online manner and continuously improve the learning process.

The process steps of the proposed system which is the subject of the invention are as follows:
Creation of the digital twin of the physical network (1) (1001),
Collection of necessary data of the physical network (1) over the digital twin (1002),
Feeding the collected data to the YANG modeling module and creation of YANG data models (4) using the YANG data modeling language (1003),
In the feature selection module (5), selecting the best (preferably 10) features from the data and feeding the data by labeling with the labeling method recommended in the MLP online learning module (6) (1004),
Decision of the MLP online learning module (6) whether the data traffic change in the network is a DDoS attack or not (1005),
Deciding whether to update the selected features by looking at the performance metrics of the MLP online learning module (6) (1006),
Updating the features used by the AutoFS module (9) (2001),
In the feature selection module (5), one thousand samples were randomly selected for six feature selection methods to use, over the data obtained, and each feature selection method selects the best ten features (2002),
Labeling data in the AutoFS module (9) (2003),
Performing training and testing in the online learning module (6) (2004),
Updating the feature selection method that the system will use and the MLP method as a result of the AutoFS module (9) (2005).
Giving one thousand labeled data samples with ten features as input to the feature selection module (5) (3001),
For the K-Means algorithm, the K value is determined as 2 and the data is divided into two groups and the interval for the initial values of the EM algorithm is determined (3002) (This also improves the consistency of the EM algorithm with the convergence rate),
Application of EM algorithm to assign probabilistic weight values to labels (3003),
Defining the base data as labeled through a thousand data samples (3004),
Using labeled and unlabeled data by the other EM algorithm and finding the maximum likelihood estimation of the parameters locally (3005),
Determining final labels by taking the output of two EM algorithms as input by collective learning algorithm (3006),
Combining the collective learning output with labeled base data (3007).

1. A system that ensures the timely and accurate detection of the problem when a Distributed Denial of Service (DDoS) attack occurs in the core of physical networks of each Internet Service Provider (ISP) that provides internet service, the system comprising:
a physical network owned by the ISP, through which data flow is provided to users;
a cloud system that runs a created digital twin of the physical network;
a digital twin of a router, which is located in the digital twin of the physical network and performs machine learning, data modeling, feature selection and data labeling methods in the system;
YANG data models that prevent the high volume of data that will occur by modeling the key performance indicator data received from the routers;
a feature selection module that performs feature selection on modeled data to be used during online learning;
an online learning module that performs the online learning method on the data obtained, using the MLP method;
a classification module that decides whether the traffic change in the network is a DDoS attack or not according to the result obtained from the learning process;
a performance evaluation module, which gives feedback to the feature selection process on the data by looking at the performance metrics obtained as a result of online learning;
an AutoFS module which determines the most appropriate feature selection method among the specified feature selection methods, according to the feedback from both the performance evaluation module and the module that contains up-to-date feature information; this module also enables online learning to process; and
a module that contains up-to-date feature information according to the notifications coming from the performance evaluation module.

2. A method for the timely and accurate detection of the problem when a Distributed Denial of Service (DDoS) attack occurs in the core of physical networks of each Internet Service Provider (ISP) that provides internet service, the method comprising:
creation of a digital twin of a physical network;
collection of necessary data of the physical network over the digital twin;
feeding the collected data to a YANG modeling module and creation of YANG data models using the YANG data modelling language (1003);
in a feature selection module, selecting the best (preferably 10) features from the data and feeding the data by labeling with the labeling method recommended in an MLP online learning module (1004);
decision of the MLP online learning module whether the data traffic change in the network is DDoS attack or not (1005); and
deciding whether to update the selected features by looking at the performance metrics of the MLP online learning module (1006).

3. The method in accordance with claim 2, comprising the following process steps:
updating the features used by an AutoFS module (2001);
in the feature selection module, one thousand samples were randomly selected for six feature selection methods to use, over the data obtained, and each feature selection method selects the best ten features (2002);
labeling data in the AutoFS module (2003);
performing training and testing in the online learning module (6); and
updating the feature selection method that the system will use and the MLP method as a result of the AutoFS module (2005).

4. The method in accordance with claim 2, comprising the following process steps:
giving one thousand labeled data samples with ten features as input to the feature selection module (3001); and
for the K-Means algorithm, the K value is determined as 2 and the data is divided into two groups and the interval for the initial values of the EM algorithm is determined (3002), which also improves the consistency of the EM algorithm with the convergence rate);
application of EM algorithm to assign probabilistic weight values to labels (3003);
defining the base data as labeled through a thousand data samples (3004);
using labeled and unlabeled data by the other EM algorithm and finding the maximum likelihood estimation of the parameters locally (3005);
determining final labels by taking output of two EM algorithms as input by collective learning algorithm (3006); and
combining the collective learning output with labeled base data (3007).
